(19) United States
(12) Patent Application Publication
(10) Pub. No.: US 2010/0282585 A1
(43) Pub. Date: Nov. 11, 2010

(54) FILM-TYPE SWITCHING ELEMENT

(75) Inventors: Peter Jonas, Konz (DE); Werner Bieck, Wiltingen (DE)

Correspondence Address: CANTOR COLBURN, LLP, 20 Church Street, 22nd Floor, Hartford, CT, 06103, US

(73) Assignee: IEE INTERNATIONAL ELECTRONICS & ENGINEERING S.A., ECHTERNACH (LU)

(21) Appl. No.: 12/666,215

(22) PCT Filed: Jun. 16, 2008
(86) PCT No.: PCT/EP08/57575

§ 371 Date: Jul. 12, 2010

(30) Foreign Application Priority Data
Jun. 22, 2007 (EP) 07110865.8

(51) Int. Cl. H01H 1/10

(52) U.S. Cl. 200/514

(57) ABSTRACT

“A film-type switching element includes a first carrier film, a second carrier film and a spacer that separates the carrier films a certain distance apart from one another, where the spacer includes a spacer film, which is arranged between and attached to the first and second carrier films, and whose thickness corresponds to the distance between the carrier films, the spacer has an opening therein, which extends between the first and second carrier films and defines the active zone of the film-type switching element, in which the first and second carrier films may be resiliently brought together in response to compressive force acting on the film-type switching element, where a contact arrangement having at least a first and a second electrode is arranged in the active zone on at least one of the first and second carrier films in such a way that an electric contact is established between the first and second electrodes when the first and second carrier films are brought together, the spacer including a frame element, separate from the spacer film, that circumferentially borders the opening, and that is held in place by a border of the spacer film turned towards the opening and at least one of the first and second carrier films.”

### TECHNICAL FIELD

The present invention generally relates to film-type switching elements.

### BACKGROUND

Film-type switching elements, such as membrane switches, film-type pressure sensors or similar devices usually include a first carrier film (also referred to as carrier foil) and a second carrier film arranged at a certain distance from one another by means of a spacer. The spacer, e.g. comprising a double-sided adhesive film, has at least one opening, which extends between the first and second carrier films, and which defines, by its contour, the active zone of the switching element. At least two electrodes are arranged within the active zone between said first and second carrier films in such a way that, in response to a pressure acting on the switching element, the first and second carrier films are pressed together against the reaction force of the elastic carrier films and an electrical contact is established between the at least two electrodes. Advantageously, the carrier films are mono- or multilayer polymer films onto which the electrodes and other elements of the electric circuit are printed or otherwise applied in form of a conductive (or resistive) ink or paste (e.g. ink comprising silver or graphite particles).

Two basic configurations exist for such switching elements. In the so-called “through-mode” variant, the first and second electrodes are arranged opposite one another in the active zone, i.e. each one of the first and second electrodes is disposed on its respective carrier film. In the so-called “shunt-mode” variant, both the first and second electrodes are arranged on the same one of the first and second carrier films, while a contact element is placed opposite the first and second electrodes on the other one of the carrier films. In each of these variants, the switching element may be implemented as a simple on-off switching element, having a substantially step-like electrical response, or as a pressure-sensitive switching element, showing a gradual decrease of resistance as a function of pressure. In the latter case, at least one of the electrodes and the contact element comprises a layer of pressure-sensitive material, whose resistance decreases continuously or by minute steps with increasing pressure being applied thereon.

The electrical response of such a switching element (e.g. the resistance or impedance between the first and second electrodes as a function of the applied pressure) depends on various parameters, including the type and shape of the electrodes, the arrangement of the electrodes within the active zone, the properties (thickness, modulus of elasticity and the like) of the carrier films, the dimensions and the configuration of the active zone, the separation between the electric elements that have to come into contact, the choice of the pressure sensitive material (if present), etc.

Both in an on-off switching element (which has no pressure-sensitive layer) and in a pressure-sensitive switching element (which has such a layer), the resistance between the first and second electrodes remains at a very high level (e.g. several MO) until increasing pressure causes the electric elements on the first and second carrier films to touch so that a current may flow between them. The pressure at which the initial physical contact occurs is referred to as threshold pressure. In an on-off switching element, the transition from highly resistive (insulating) state to conductive state occurs abruptly, i.e. in a narrow pressure range. Modifying the above parameters basically results in shifting the threshold from lower pressure values to higher ones or vice-versa. In a pressure-sensitive switching element, the transition takes place over a broader pressure range (i.e. with a smaller slope or with through a plurality of small steps); in this case, the above parameters not only have an influence on the threshold pressure but also on the appearance of the curve describing the electrical response as a function of pressure. Ways to tailor the electrical response of switching elements are described, for instance, in U.S. Pat. No. 7,187,264, U.S. Pat. No. 7,064,650 and US 2005/0006216 A1.

The above-described switching elements can be manufactured cost-effectively and have proven to be extremely robust and reliable in practice. That is the reason why such switching elements are commonly used in automotive safety applications e.g. as seat occupation sensors for seat belt reminders or for controlling auxiliary restraint systems.

A concern in the production of switching elements, e.g. for the automotive industry, is to guarantee substantially the same electrical response throughout a specified temperature range (such as from −40° C. to 105° C. for the automotive industry). Different measures for enhancing the uniformity of the response of such switching elements as a function of temperature have already been proposed. For instance, WO-A-2004/053908 discloses a foil-type switching element wherein at least one of the carrier films comprises a multi-layered configuration with at least two layers of different materials. By the use of appropriate materials and by suitably dimensioning the thickness of the different layers, the mechanical properties of these multi-layered carrier films may be precisely tuned to the specific requirements of a wide range of applications. WO 2006/058880 describes various carrier film materials having improved behaviour with respect to the more conventional carrier film materials like polyethylene terephthalate (PET) and polyethylene naphthalate (PEN).

### BRIEF SUMMARY

The disclosure provides a film-type switching element having reduced sensitivity to temperature variations.

A film-type switching element comprises, as mentioned hereinbefore, a first carrier film, a second carrier film and a spacer that separates the carrier films a certain distance apart from one another. The spacer includes a spacer film, e.g. a double-sided adhesive film, which is arranged between and attached to the first and second carrier films, and whose thickness corresponds to the distance between the carrier films. The spacer has an opening therein, which extends between the first and second carrier films and defines the active zone of the film-type switching element, i.e. the region in which the first and second carrier films may be resiliently brought together in response to compressive force acting on the film-type switching element. A contact arrangement comprising at least a first and a second electrode is arranged in the active zone on at least one of the first and second carrier films in such a way that an electric contact is established between the first and second electrodes when the first and second carrier films are brought together. According to an important aspect of the invention, the spacer comprises a frame element, separate from (i.e. not incorporated within) the spacer film, which circumferentially extends around the opening so as to border (i.e. frame) the opening on its entire height or a part thereof. The frame element is held in place, relative to the spacer film, by a border surface of the spacer film turned towards the opening (in the plane of the spacer film) and at least one of the first and second carrier films (in the direction perpendicular to the plane of the spacer film). For the purposes of the present the term “film” is to be understood as designating a comparatively thin, flexible membrane, i.e. a sheet-like barrier of material.

In the investigations leading to the present invention, it was discovered that deformations induced by a mismatch of the thermal expansion coefficients of carrier film materials and spacer materials affect the response of the switching element to a much larger extent than expected. This is true, in particular, for switching elements in which the spacer film comprises layers of adhesive, by means of which its is attached to the carrier films, since the thermal behaviour of these adhesives normally substantially differs from that of the carrier films. The mismatch of the thermal expansion coefficients leads to deformations of the carrier films at the active zones, where the carrier films are not supported by the spacer film. In particular, the carrier films may bend into the opening in response to a temperature change so that they get closer to one another even without any external pressure being applied. Those skilled will appreciate that the frame element of the invention supports at least one of the carrier films around the opening. Accordingly, stress induced by a temperature variation at the edge of the spacer layer in contact with the carrier film does no longer cause bending of the carrier film into the opening because the frame element opposes to such deformation. Preferably, the frame element is made of a material having substantially the same thermal behaviour as at least one (more preferably: both) of the carrier films (i.e. the thermal expansion coefficient of the frame element lies preferably in the range from about 50 to about 150% of the thermal expansion coefficient of the carrier films). For instance, for preferred carrier films comprising PET film, PEN film and/or PI film, the thermal expansion coefficient typically ranges from 20 to 60 ppm/K; the thermal expansion coefficient of the frame element in this case preferably ranges from about 10 to about 100 ppm/K. More specifically, if the carrier films have a thermal expansion coefficient of about 40 ppm/K, the frame element is preferably chosen so as to have a thermal expansion coefficient in the range from about 20 to about 60 ppm/K. Most preferably, the frame element is made of the same material as at least one of the carrier films, so that the thermal expansion of the frame element corresponds to that of the carrier film.

According to a preferred embodiment of the invention, the frame element has a height corresponding substantially to the thickness of the spacer film (i.e. to the height of the border of the spacer film turned towards the opening) such that it is held in place by both the first and second carrier films. As will be appreciated, in this embodiment, the spacer film is not immediately contiguous to the active zone, but is separated from it by the “wall” formed by the frame element. To further describe such a frame element, it will be referred to the “first front surface” to designate the part of the surface of the frame element that is normally in contact with the first carrier film, to the “second front surface” to designate the part of the surface of the frame element that is facing towards or is in contact with the second carrier film, the “inner side surface” to designate the part of the surface of the frame element that delimits the opening and to the “outer side surface” to designate the part of the surface of the frame element that is in contact with the border of the spacer film holding the frame element in place. The first and second front surfaces are essentially parallel to one another. It will also be referred to the “inner contour” and the “outer contour” of the frame element to designate the curve obtained by projecting the inner side surface or the outer side surface, respectively, onto one of the carrier films.

As will be appreciated, the shape of the frame element may be chosen among a great variety of possibilities, depending on the requirements of the specific application of the switching element. The simplest and possibly the most used shape is that of a perforated annular disk, having an inner diameter corresponding to the diameter of the opening and an outer diameter fitting into the recess or gap accommodating the frame element in the spacer film. It shall be noted that the outer contour of the frame element does not necessarily correspond to the inner contour (the inner contour could e.g. be circular while the outer is polygonal, elliptical, star-shaped, etc., and vice versa). The inner contour could also be given a shape as described in U.S. Pat. No. 7,187,264, so as to define the active zone as a union of a convex inner region and peripheral outer regions extending radially outwardly (in the plane of the spacer film) from the convex inner region. The width of the frame element in the radial directions (i.e. those directions that depart radially from the middle or the geometric centre of the active zone in the plane defined by the spacer film) preferably amounts to between 10 and 30% (more preferably between 15 and 25%) of the diameter or the largest dimension of the active zone.

According to an embodiment of the invention, the frame element is held in place, in the plane of the spacer film, by form fit with the latter, i.e. the outer contour of the frame element is conjugate to the contour of the recess or gap that accommodates the frame element in the spacer film.

Those skilled will appreciate that, in principle, no bonding (no gluing, in particular) of the frame element to the carrier films and the spacer film is necessary, since the frame element is secured in position by the adjoining spacer film and carrier films. Notwithstanding that, the frame element may also be welded to at least one of the first and second carrier films, e.g. by ultrasonic welding. It should be noted that the response of the switching element is different in these two variants. Indeed, in the first variant, the carrier film that is depressed into the opening in the frame element may partially lift off from the frame element while pivoting about the inner edge of the frame element. In the second variant, such lifting off is reduced or rendered impossible.

As another measure to tailor the response of the switching element, the transition region between the inner surface and the first front surface of the frame element or the transition region between the inner surface and the second front surface of the frame element may be formed as a rounded or partially rounded edge.

For the sake of completeness, it shall be noted that the switching element of the present invention may be implemented both as an on-off switching element and as a pressure-sensitive switching element, as defined in the introduction. The switching element may be configured as a through-mode switching element, having the first electrode arranged on the first carrier film and the second electrode on the second carrier film in facing relationship with the first electrode. Alternatively, the switching element may be configured as a shunt-mode switching element, in which both the first and second electrodes are arranged on one of the first and second carrier films, and in which a contact element is arranged on the other one of the first and second carrier films, in facing relationship with the first and second electrodes in such a way that the electric contact between the first and second electrodes is established via the contact element as the first and second carrier films are brought together.

### BRIEF DESCRIPTION OF THE DRAWINGS

Further details and advantages of the present invention will be apparent from the following detailed description of several not limiting embodiments with reference to the attached drawings, wherein:

FIG. 1 is a cross sectional view of a switching element according to a preferred embodiment of the invention;

FIG. 2 is a cross sectional view of the switching element of FIG. 1 exposed to pressure;

FIG. 3 is a horizontal cross sectional view of the plane III-III of FIG. 1;

FIG. 4 is a cross sectional view of a variant of the switching element of FIG. 1 while being exposed to pressure;

FIG. 5 is a cross sectional view of a switching element according to another preferred embodiment of the invention;

FIG. 6 is a cross sectional view of a switching element according to yet another embodiment of the invention;

FIG. 7 is a cross sectional of the switching element of FIG. 6 while being exposed to pressure;

FIG. 8 is a horizontal cross sectional view of a switching element according to yet another embodiment of the invention;

FIG. 9 is a cross sectional view of a conventional switching element;

FIG. 10 is a cross sectional view of the conventional switching element of FIG. 9 showing deformations caused by a mismatch of the thermal expansion coefficients.

### DESCRIPTION OF PREFERRED EMBODIMENTS

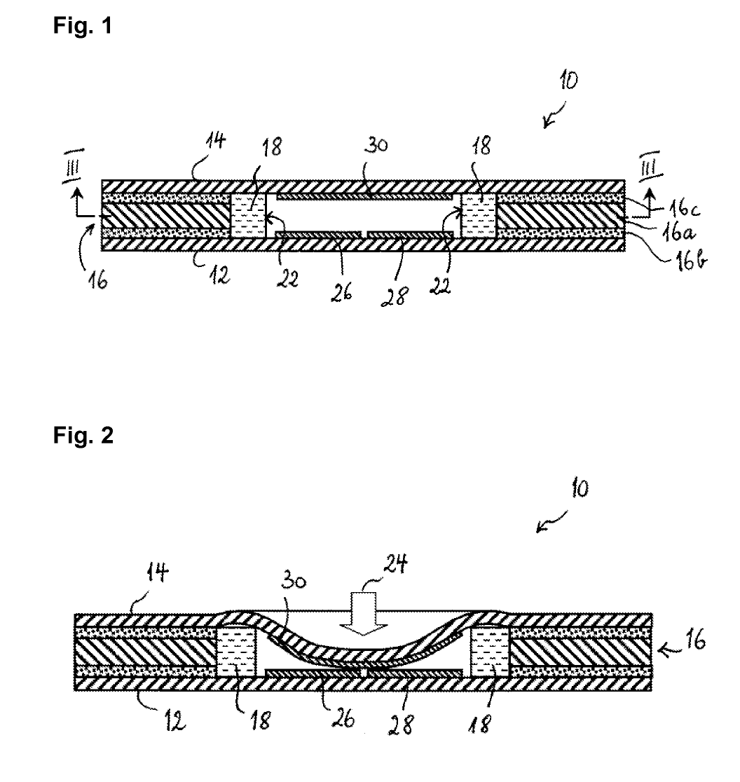

A switching element according to first preferred embodiment is generally referenced with numeral 10 in FIGS. 1-3. The switching element 10 comprises first and second flexible, electrically insulating carrier films 12, 14 made of a thin sheet of polymer material, such as, for instance, PET, PEN, PI (polyimide), polycarbonate, copolycarbonate, PEEK (polyetheretherketone), polyphenylene ether, polyamide, or the like. The thickness of the carrier films preferably lies in the range from 50 to 500 μm, more preferably in the range from 75 to 250 μm and still more preferably in the range from 100 to 175 μm. The carrier films 12, 14 are arranged at a distance (e.g. in the range from 50 to 200 μm, more preferably from 75 to 150 μm and still more preferably from 80 to 100 μm) from one another by a spacer film 16 and a frame element 18. The spacer film 16 is of a multilayered structure, including a core polymer layer 16a and outer adhesive (e.g. acrylic-based) layers 16b and 16c. The total thickness of the spacer film (i.e. the sum of the thicknesses of the layers 16a, 16b and 16c) corresponds to the distance between the carrier films 12, 14. The frame element 18 is made of the same material as the carrier films 12, 14 and is held in place by the spacer film border surface that is turned towards the opening and by the first and second carrier films 12, 14.

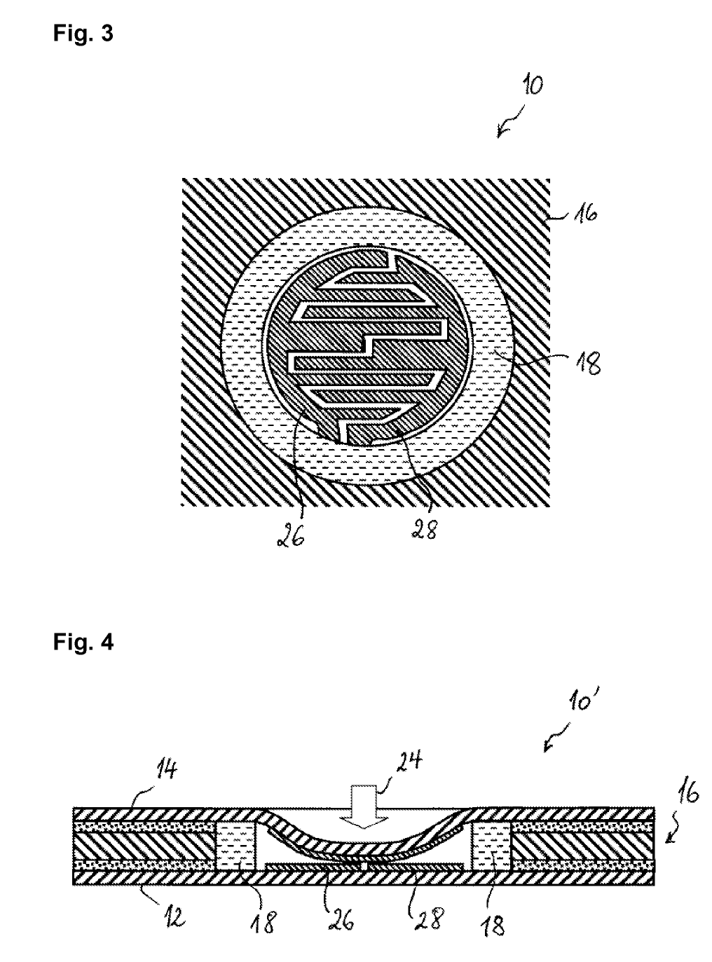

The spacer film 16 is provided with a gap (or recess) therein, in which the frame element 18 is accommodated. The outer side surface of the frame element 18 is in contact with the border of the spacer film 16 delimiting the gap, in such a way that the frame element 18 is held in position by the spacer film 16. The inner side surface 22 of the frame element 18 delimits an opening in the spacer arrangement formed by the spacer film 16 and the frame element 18. The opening defines the active zone of the switching element 10. As illustrated in FIG. 3, the active zone of the switching element 10 is substantially circular. Typically, the diameter of such an active zone lies in the range from 0.5 to 1.5 cm.

The first and second carrier films span over the opening and may be brought closer to one another as pressure (indicated by arrow 24) is exerted on them (FIG. 2). In the active zone, the first carrier film 12 bears a first and a second electrode 26, 28 on the surface facing towards the second carrier film 14. Opposite the first and second electrodes, the second carrier film 14 bears a contact element 30 on the surface facing towards the first carrier film 12.

The electrical resistance between the first and second electrodes 26, 28 is very high (in the MO range or above) as long as the contact element 30 is not pressed onto the electrodes 26, 28. If the pressure 24 applied to the switching element exceeds a certain threshold, the contact element 30 gets into contact with the first and second electrodes, as a consequence of which the resistance between the latter drops dramatically. If at least one of the first and second electrodes and the contact element comprises a layer of pressure-sensitive material (not shown in the drawings), the electrical resistance decreases gradually with increasing pressure.

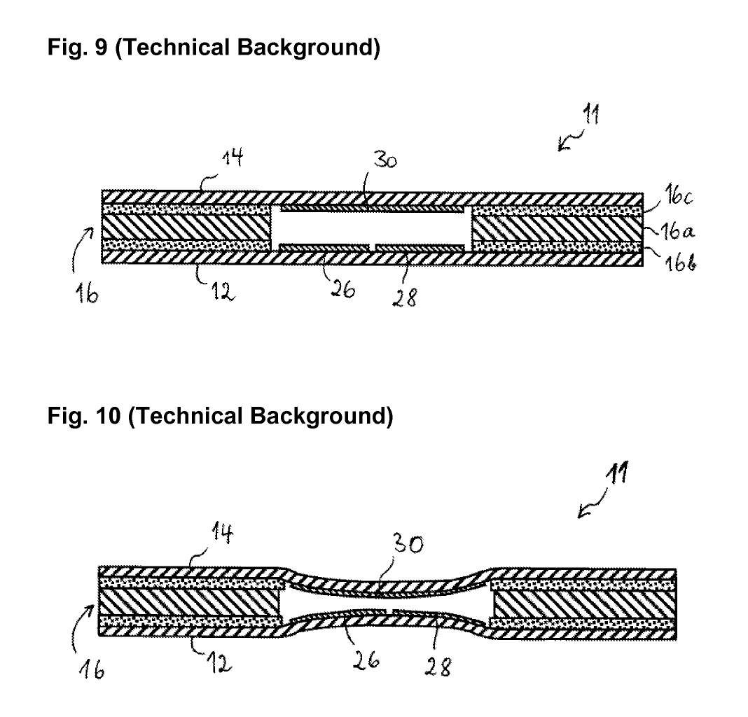

Those skilled will appreciate that the frame element 18 prevents deformations induced by a mismatch between the thermal expansion coefficients of the material of the carrier films 12, 14 materials and one or more of the materials of the spacer film. For comparison, FIGS. 9 and 10 illustrate a conventional switching element 11 that is not equipped with a frame element bordering the active zone. FIG. 10 shows (exaggeratedly) the deformations such a conventional switching element 11 may undergo as the temperature changes. At the border of the spacer film 16, the carrier films 12, 14 are bend inwardly into the active zone, which results in a change of the geometry of the pressure sensitive switching element and also in biasing the carrier films 12, 14. In the switching element 10 of FIGS. 1-3, in contrast, the frame element 18 compensates the bending moment at the border of the spacer film 16 and the carrier films remain substantially at the same distance for a larger temperature range.

In the switching element 10 of FIGS. 1-3, the frame element 18 is not fixed to the carrier films. As pressure is applied on the active zone of the switching element 10, the carrier film that is bended by the applied pressure (in the drawing, this is the second carrier film 14 but it could also be the first carrier film or both) may pivot about an inner edge of the frame element and partially lift off from the associated front surface of the frame element 18. In the variant 10′ of the switching element shown in FIG. 4, the frame element has been fixed to the carrier films 12, 14 by ultrasonic welding. As a result, the carrier films 12, 14 remain in contact with the front surfaces of the frame element 18 when pressure 24 is applied. Accordingly, the switching elements 10 and 10′ of FIGS. 2 and 4, respectively, have different response functions. It shall be noted that the frame element 10′ is not glued to the carrier films 12, 14 since glue normally has a thermal expansion coefficient that does not match with the one of the carrier films 12, 14.

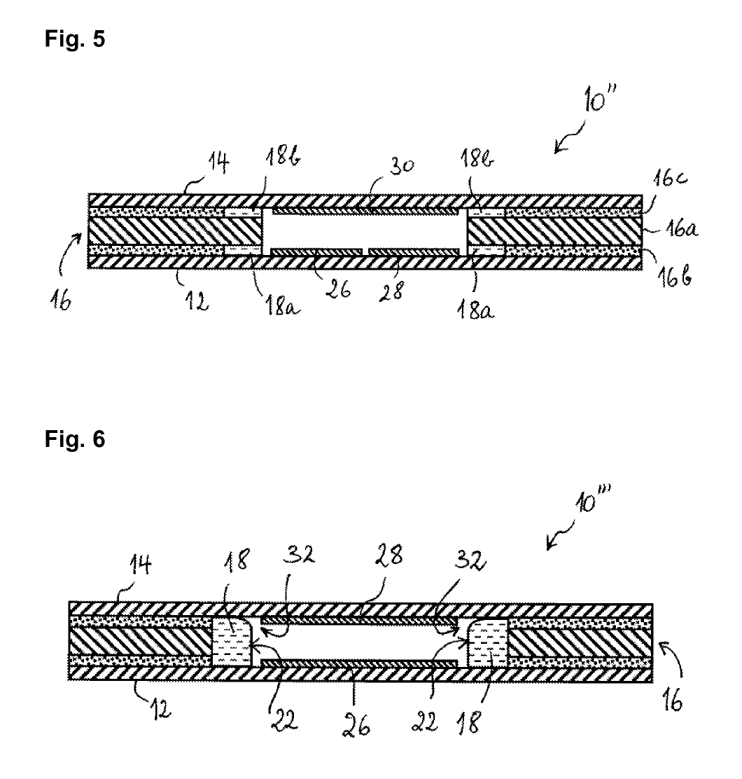

FIG. 5 shows a switching element 10″ comprising two frame elements 18a and 18b, each of which circumferentially borders the active zone on only a part of its height. In the embodiment of FIG. 5, the adhesive layers 16b, 16c of the spacer film 16 do not extend to the very border of the active zone. Instead, it is the frame elements 18a and 18b that support the carrier films 12, 14 at the border of the spacer film 16.

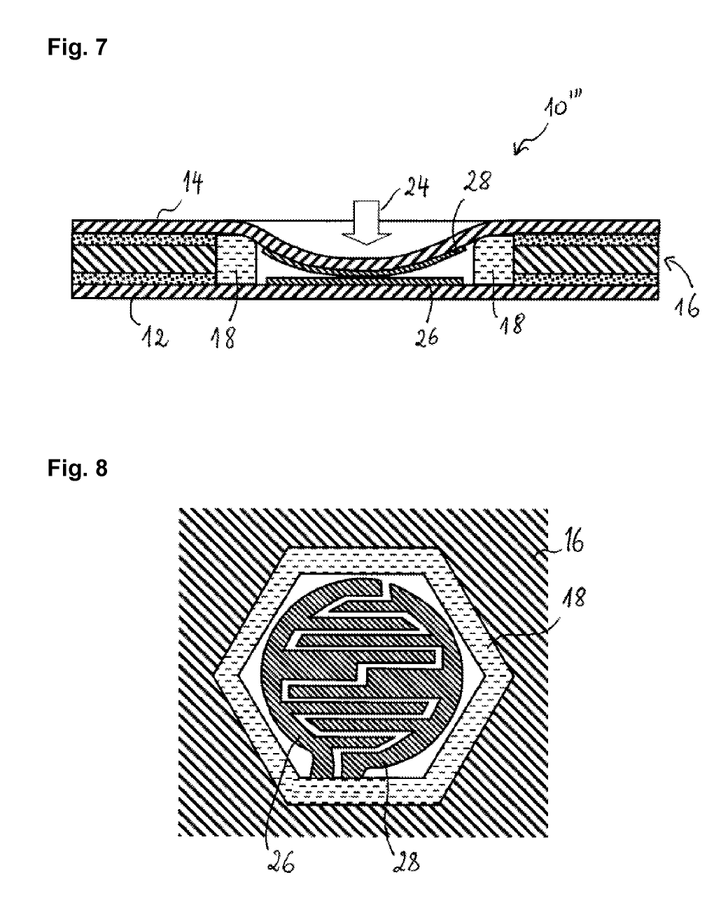

FIGS. 6 and 7 show yet another embodiment 10″′ of a switching element. The switching element 10″′ is of the through-mode type. The first electrode 26 is applied on the inner surface of the first carrier film 12; the second electrode 28 is applied on the inner surface of the second carrier film 14, in facing relationship with the first electrode 12. The switching element 10″′ includes a frame element 18 whose front surface in contact with the second carrier film 14 forms a rounded edge 32 with the inner side surface 22 delimiting the active zone. The provision of a rounded edge 32 increases the effective bending radius of the carrier film 14 when subjected to pressure and reduces the lift-off of the carrier film 14 in case it should not be fixed to the frame element 18. Those skilled will appreciate that such rounded edges may be incorporated into switching elements more easily thanks to the presence of the frame elements, since these may be manufactured separately from the spacer films. Those skilled will further appreciate that also the transition region between the front surface in contact with the first carrier film 12 and the inner side surface 22 could be achieved as a rounded edge, depending on the requirements of the specific application of the switching element 10″′.

FIG. 8 is a horizontal cross sectional view of a switching element with a hexagonal active zone for illustration of the fact that the shape of the frame element 18 may depart from the circular shape.

As will be apparent to those skilled, the switching elements described with reference to FIGS. 1-5 and 8 may be configured as through-mode switching elements and the switching element described with reference to FIGS. 6 and 7 may likewise be configured as a shunt-mode switching element without departing from the scope of the present invention.

1-10. (canceled)

11. A film-type switching element, comprising:
a first carrier film and a second carrier film;
a spacer including a spacer film arranged between and attached to said first and second carrier films in such a way that said first and second carrier films are spaced from one another by a distance corresponding to a thickness of said spacer film;
said spacer having therein an opening extending between said first and second carrier films, said opening defining an active zone of said film-type switching element, in which said first and second carrier films may be resiliently brought together in response to compressive force acting on said film-type switching element;
a first and a second electrode arranged in said active zone on at least one of said first and second carrier films in such a way that an electric contact is established between said first and second electrodes as said first and second carrier films are brought together;
wherein said spacer comprises a frame element separate from said spacer film, said frame element extending circumferentially around said opening so as to border said opening, said frame element being held in place by a border of said spacer film and at least one of said first and second carrier films.

12. The film-type switching element as claimed in claim 11, wherein said frame element has a height corresponding substantially to the thickness of said spacer film and wherein said frame element is held in place by both said first and second carrier films.

13. The film-type switching element as claimed in claim 11, wherein said frame element is held in place by form fit with said spacer film.

14. The film-type switching element as claimed in claim 11, wherein said frame element is welded to at least one of said first and second carrier films.

15. The film-type switching element as claimed in claim 11, wherein said frame element is made of the same material as at least one of said first and second carrier films.

16. The film-type switching element as claimed in claim 11, wherein said frame element has the shape of a perforated annular disk.

17. The film-type switching element as claimed in claim 11, wherein said frame element has
a first front surface in contact with said first carrier film;
a second front surface in contact with said second carrier film, said first and second front surfaces being essentially parallel to one another;
an inner side surface delimiting said opening; and
an outer side surface in contact with said border of the spacer film holding the frame element in place.

18. The film-type switching element as claimed in claim 17, wherein at least one of a transition between said inner surface and said first front surface and a transition between said inner surface and said second front surface is formed as a rounded edge.

19. The film-type switching element as claimed in claim 11, wherein said wherein said first electrode is arranged on said first carrier film and wherein said second electrode is arranged on said second carrier film in facing relationship with said first electrode.

20. The film-type switching element as claimed in claim 11, wherein both said first and second electrodes are arranged on one of said first and second carrier films, and wherein a contact element is arranged on the other one of said first and second carrier films, in facing relationship with said first and second electrodes in such a way that said electric contact between said first and second electrodes is established via said contact element as said first and second carrier films are brought together.

21. A film-type switching element, comprising:
a first carrier film and a second carrier film;
a spacer film arranged between and attached to said first and second carrier films in such a way that said first and second carrier films are spaced from one another by a distance corresponding to a thickness of said spacer film, said spacer film having therein an opening extending between said first and second carrier films,
a frame element in form of a perforated annular disk separate from said spacer film and extending circumferentially around said opening so as to frame said opening, said frame element being held in place by a border of said spacer film and at least one of said first and second carrier films;
wherein said opening defines an active zone of said film-type switching element, in which said first and second carrier films may be resiliently brought together in response to compressive force acting on said film-type switching element;
wherein said film-type switching element comprises a first and a second electrode arranged in said active zone on at least one of said first and second carrier films in such a way that an electric contact is established between said first and second when said first and second carrier films are brought together.

22. The film-type switching element as claimed in claim 21, wherein said frame element has a height corresponding substantially to the thickness of said spacer film and wherein said frame element is held in place by both said first and second carrier films.

23. The film-type switching element as claimed in claim 21, wherein said frame element is held in place by form fit with said spacer film.

24. The film-type switching element as claimed in claim 21, wherein said frame element is welded to at least one of said first and second carrier films.

25. The film-type switching element as claimed in claim 21, wherein said frame element is made of the same material as at least one of said first and second carrier films.

26. The film-type switching element as claimed in claim 21, wherein said frame element has
a first front surface in contact with said first carrier film;
a second front surface in contact with said second carrier film, said first and second front surfaces being essentially parallel to one another;
an inner side surface delimiting said opening; and
an outer side surface in contact with said border of the spacer film holding the frame element in place.

27. The film-type switching element as claimed in claim 26, wherein at least one of a transition between said inner surface and said first front surface and a transition between said inner surface and said second front surface is formed as a rounded edge.

28. The film-type switching element as claimed in claim 21, wherein said wherein said first electrode is arranged on said first carrier film and wherein said second electrode is arranged on said second carrier film in facing relationship with said first electrode.

29. The film-type switching element as claimed in claim 21, wherein both said first and second electrodes are arranged on one of said first and second carrier films, and wherein a contact element is arranged on the other one of said first and second carrier films, in facing relationship with said first and second electrodes in such a way that said electric contact between said first and second electrodes is established via said contact element when said first and second carrier films are brought together.
